(19) United States
(12) Patent Application Publication
(10) Pub. No.: US 2017/0046752 A1
(43) Pub. Date: Feb. 16, 2017

(54) MULTI-CRITERIA RATING FOR DIFFERENT ENTITY TYPES

(71) Applicant: International Business Machines Corporation, Armonk, NY (US)

(72) Inventors: Matthias Diester, Stuttgart (DE); Stephan Laertz, Herrenberg (DE); Andreas Nauerz, Stuttgart (DE); Thomas Steinheber, Stuttgart (DE)

(21) Appl. No.: 14/825,552

(22) Filed: Aug. 13, 2015

(51) Int. Cl. G06Q 30/02

(52) U.S. Cl. CPC G06Q 30/0282

(57) ABSTRACT

Multi-criteria rating of resources comprises, in some embodiments, defining and storing a resource type, defining and storing pre-determined rating criteria, and defining and storing user interface representations. Additionally, multi-criteria rating may comprise assigning one out of the user interface representations to each of the pre-determined rating criteria, respectively, assigning at least one out of the pre-determined rating criteria to the resource type, thereby generating resource-type-specific rating criteria out of the pre-determined rating criteria, and assigning rating values to resource-type-specific rating criteria for the resource associated with the resource type. Additionally, multi-criteria rating may comprise selecting resources by comparing respective rating values of resources with the resource-type-specific rating criteria values.

### BACKGROUND

The present invention relates generally to the field of marketing resources, and more particularly to rating of resources.

In today's interconnected world all kind of resources get rated. Many user selections of users depend on information about such resources which is often based on such ratings. Rating may be understood as an evaluation or assessment of something, in terms of quality (as with a critic rating a novel), quantity (as with an athlete being rated by his or her statistics), or some combination of both. It may describe the process of assigning (e.g., numeric) “values” to resources indicating how much people “like” those.

A rating itself is “some value” associated to a resource. Ratings are usually chosen from an interval of possible “values,” whereas the one end of the interval usually refers to “dislike” and the other to “like.

### SUMMARY

According to aspects of the present invention, there is a method, computer program product and/or system for a multi-criteria rating of resources that performs the following operations: defining and storing a resource type; defining and storing a set of pre-determined rating criteria; defining and storing a set of user interface representations; assigning a first user interface representation from the set of user interface representations to one or more of the pre-determined rating criteria from the set of pre-determined rating criteria; assigning at least one pre-determined rating criterion of the set of pre-determined rating criteria to the resource type, thereby generating a resource-type-specific rating criterion; assigning a rating value to the resource-type-specific rating criterion for a set of resources respectively, the set of resources designated as the resource type; and selecting a resource by comparing the rating value respectively assigned to each resource of the set of resources.

### BRIEF DESCRIPTION OF THE SEVERAL VIEWS OF THE DRAWINGS

FIG. 1 shows a block diagram of an embodiment of the inventive computer-implemented method for a multi-criteria rating of resources;

FIG. 2 shows a block diagram of a general architecture embedded into a portal architecture;

FIG. 3 shows a block diagram of an embodiment of various user interface representations for ratings;

FIG. 4 shows an embodiment of a rating widget in use for various resources;

FIG. 5 shows an embodiment of a selection result for resources;

FIG. 6 shows an embodiment of an input portlet for adding a user-specific criterion for a resource type;

FIG. 7 shows a first embodiment of an assignment of a user interface representation for a user-specific criterion for a resource type;

FIG. 8 shows a second embodiment of an assignment of a user interface representation for a user-specific criterion for a resource type;

FIG. 9 shows a flowchart for registering a new rating criterion;

FIG. 10 shows a flowchart describing a configuration of a UI representation for a rating criterion;

FIG. 11 shows a flowchart of creating rating values, in particular by a user;

FIG. 12 shows a flowchart showing a flow of actions for a search/selection based on rating criteria;

FIG. 13 shows an overview block diagram of an embodiment of a rating system for a multi-criteria rating of resources; and

FIG. 14 shows a schematic view of a computing system according to the present invention.

### DETAILED DESCRIPTION

Embodiments of the invention provide a way to assist a user in gaining deeper understanding of reasons behind a particular rating value that has been assigned. In the following, a detailed description of the figures will be given. All instructions in the figures are schematic. Firstly, a block diagram of an embodiment of the inventive computer-implemented method for a multi-criteria rating of resources is given. Afterwards, further embodiments as well as embodiments of the rating system for a multi-criteria rating of resources will be described.

It should be noted that some embodiments of the present invention are described with reference to different subject-matters. In particular, some embodiments are described with reference to method type claims whereas other embodiments have been described with reference to apparatus type claims. However, a person skilled in the art will gather from the above and the following description that, unless otherwise notified, in addition to any combination of features belonging to one type of subject-matter, also any combination between features relating to different subject-matters, in particular, between features of the method type claims, and features of the apparatus type claims, is considered as to be disclosed within this document.

The aspects defined above and further aspects of the present invention are apparent from the examples of embodiments to be described hereinafter and are explained with reference to the examples of embodiments, but to which the present invention is not limited.

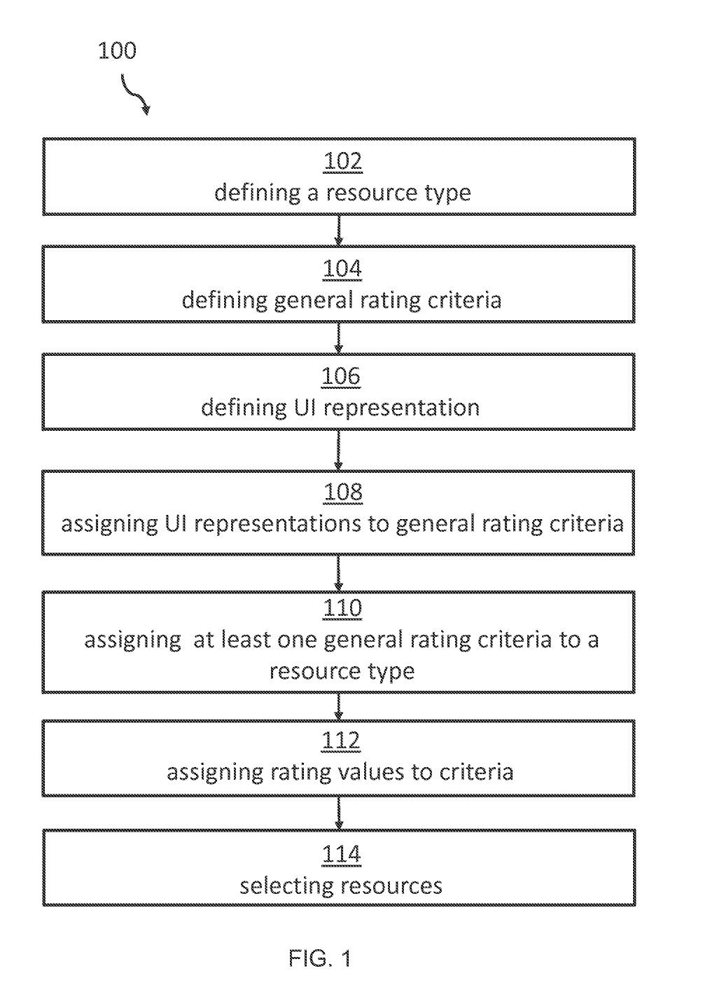

FIG. 1 shows a block diagram of an embodiment of computer-implemented method 100 for multi-criteria rating of resources. The method 100 may comprise defining and storing, 102, in particular in a registry, a resource type. Typically, more than one resource type is defined and stored in a registry or database. Examples are, for example, cars, movies, houses, travel location, and hotels. The method may also comprise defining and storing, 104, general rating criteria (also referred to herein as a pre-determined rating criteria). These may still be independent of resource types. Additionally, the method may comprise defining and storing, 106, user interface (UI) representations, as well as assigning, 108, one user interface representation out of a set of user interface representations to each of the general rating criteria, respectively. Furthermore, the method 100 may comprise assigning, 110, at least one general rating criterion, out of a set of general rating criteria, to the resource type, thereby generating a set of resource-type-specific rating criteria out of the set of general rating criteria. Up to here, all activities may be performed by an administrator of a rating system. The following, additional activities as part of the method 100 may be performed by a different user.

A user may now assign, 112, rating values to resource-type-specific rating criteria for the resource associated with the resource type. Then, resources, in particular one or also none (if not fit), may be selected, 114, by comparing respective rating values of resources with the resource-type-specific rating criteria values. The results of the selecting may be displayed to a user. The information about the resources may be stored in a database, may be sourced from the Internet or a combination thereof.

One optional embodiment of the method 100 may comprise defining weights for each of the resource-type-specific rating criteria. This may individualize the search for specific resources if the weighing may be applied before the selection. Different users may assign different weights to different criteria.

According to one additional embodiment of the method 100, a user may define a user-specific resource-type-specific rating criterion and assigning it to the resource type. This may have the advantage that a user may not only use predefined rating criteria and assign values to those, but also add additional rating criteria for a further individualization. If general rating criteria, or pre-determined rating criteria, such as “color”, “price”, “power consumption” are assigned to a particular resource type, then a user may pay special attention to haptics or durability as additional rating criteria. According to some embodiments of the present invention, this scenario may advantageously be enabled. It should also be noted that the option of adding additional rating criteria bear not only an individualization aspect, but also a general aspect. All other users may benefit from this additional rating criterion as well. Where a user adds the rating criterion “haptics,” the whole user community, or all other users of a related system, may benefit from this and may rate the related resource also with this new rating criterion. Accordingly, the crowd-sourced wisdom of an additional rating criterion may enhance both functionality for the individual user/contributor, but also allow other users to take advantage of the individual's insight.

Accordingly, the method 100 may also comprise a selection by a user one of the already-defined user interface representations. Thus, the user-defined rating criterion may have a suitable UI representation.

According to some embodiments of the present invention, a suggestor may be instrumental for defining a user-specific (also referred to as user-based) resource-type-specific rating criterion. For this purpose, a selection from of a list of potential user-based resource-type-specific rating criteria generated by a suggestor may be performed. Hence, the user may not be required to think through all possible additional rating criteria, but will get proposals for additional rating criteria.

As suggestor techniques, the following may be used alone or in combination: (i) a type-ahead suggestor; (ii) a folksonomy suggestor; and (iii) a suggestor performing semantic text analysis of a resource type description to suggest a new specific resource-type-specific rating criterion.

Some embodiments of the present invention are directed to automated selection of a resource based on a comparison of each rating value respectively assigned to each resource of the set of resources. In some embodiments, a resource having the higher value is selected. Automated selection may be based on pre-defined preferences for selecting a resource based on a set of rating values corresponding to various resources. As discussed herein, rating values themselves may be customized according to a user preference, which is implemented, in some embodiments, by weighting particular criteria above other criteria.

All of the above-mentioned various embodiments may also be applicable for the rating system for a multi-criteria rating of resources.

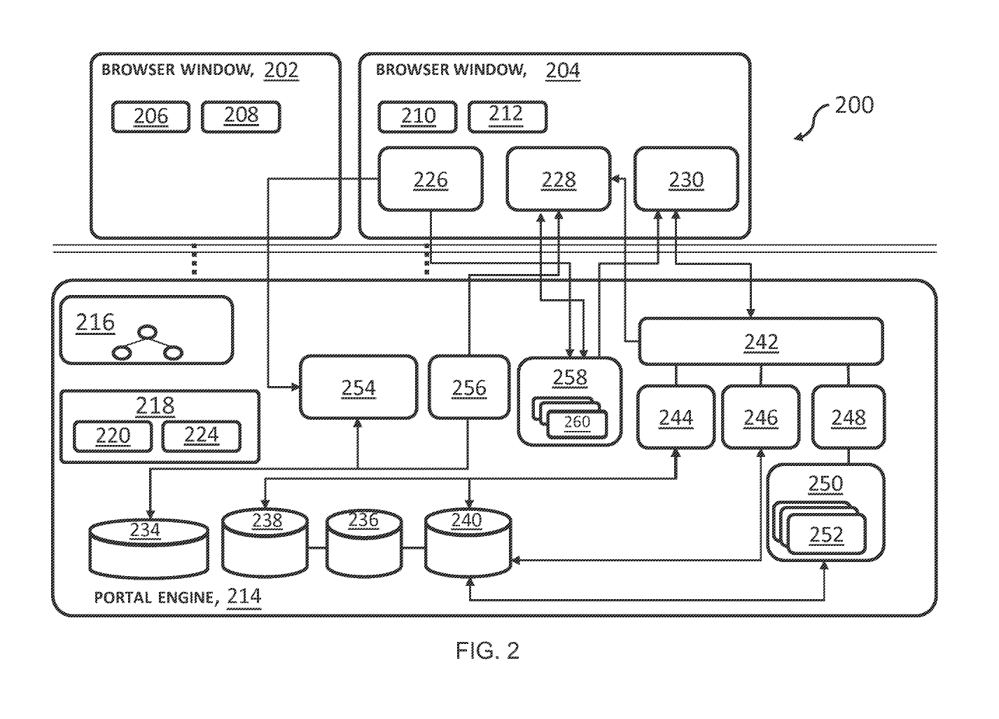

FIG. 2 shows a block diagram, a general architecture 200 for method 100, which is embedded into a portal architecture. The following elements may be known from a traditional portal infrastructure: (i) on the client side, there may be one or two browser windows 202, 204 and each of these browser windows may display a portal page comprising portlets 206, 208, 210, 212; and (ii) on the server-side, the elements of a portal engine 214 include a page aggregator 216 and a portal container 218 for storing portlet set up data 220, 224.

Some embodiments of the present invention include, on the client side and as part of the multi-criteria rating architecture, the following components: a rating criteria search widget 226; a rating widget 228; and a rating criteria management widget 230, all of which may be displayed as part of a portal/browser window 202, 204.

The portal engine 214 may comprise a resource rating store 234, a resource type store 236, a resource store 238, and a type criteria store 240. A rating criteria management engine may control a resource type rating criteria engine 244, a rating criteria consolidation engine 246 and a rating criteria suggestion engine 248. The rating criteria suggestion engine 248 may be linked to a criterion suggestor registry 250 comprising pluggable suggestors 252.

Additionally, the portal engine 214 may comprise a rating criteria search engine 254, a rating service 256 as well as a rating UI artifact registry 258 comprising pluggable rating UIs 260.

Data flows and information flows between the different components of the general architecture 200 for the inventive method 100 are shown as arrows linking the different components of the portal pages 202, 204 and the portal engine 214.

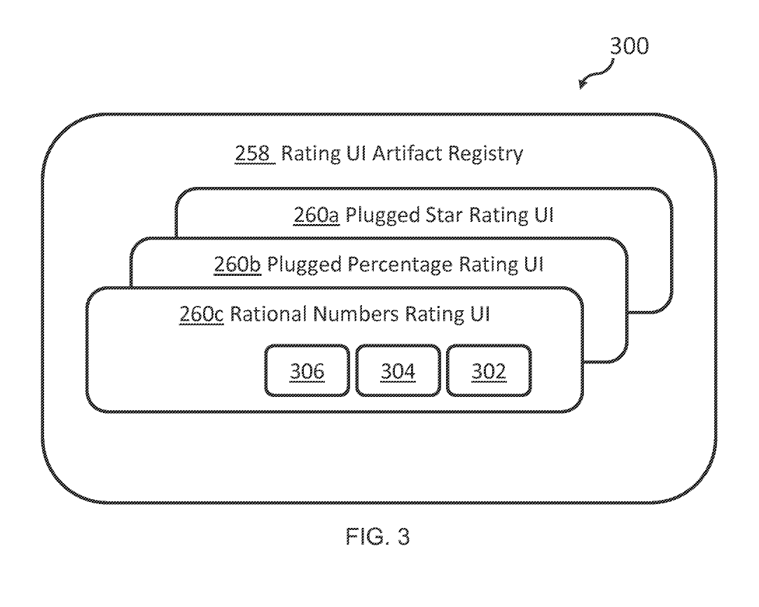

FIG. 3 shows a block diagram 300 of entries in a rating UI artifact registry 258. Each registered and pluggable rating UI 260a, 260b, and 260b includes a UI control for assigning rating values 302, a UI for defining a search range of rating values 304, and a definition of a valid range of rating values 306.

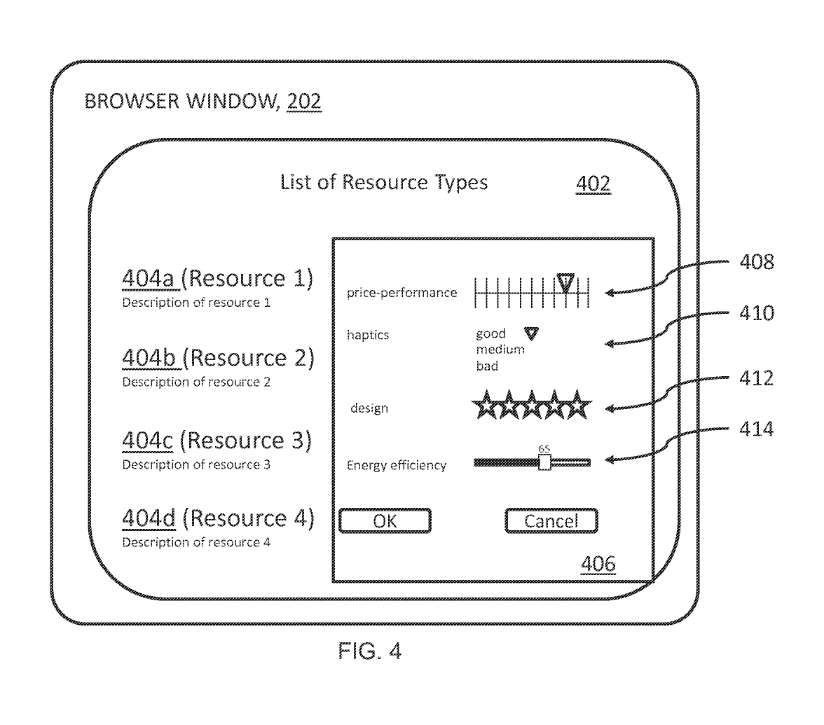

FIG. 4 shows an embodiment of a rating widget in use for different resources. On the left side of portlet 402 of browser window 202, various resources 404a, 404b, 404c, and 404d are displayed to a user. Along with every resource a short description may be displayed for that specific resource. If, for example, a user rates different refrigerators, the names of the different refrigerators are displayed as various resources, such as fridge A, fridge B, fridge C, and fridge D. The resources 1 through 4 are shown as a placeholder for specific resources that may be the subject of ratings. Resources may be any product or service that may be rated by a user. Resources may include: (i) travel destinations; (ii) travel agencies; (iii) a car; (iv) shopping centers; and (v) mobile phones.

The user may select one of the resources, such as resource 404a by clicking on the resource link. As a consequence, the rating widget 406, which may correspond to the rating widget 228 of FIG. 2, for rating the resource may be rendered. Different rating values for the different rating criteria may be assigned. The rendered user interface for assigning ratings to the given criteria may be those that have been pre-defined by an administrator or others that have been additionally defined by a user.

A list of values may be displayed as a grid of fixed rating numbers, 408. This may be, for example, applicable for a price-performance-ratio criterion, as it may have been defined before by the administrator. For another criterion such as the criterion “haptics”, a more relative rating may be advantageous. For such a criterion, three criteria values may be sufficient and, therefore, the respective rating assignment user interface is displayed as specified for the rating criterion at hand. Criterion 410 in this example is shown with the ratings “good,” “medium,” and “bad.” Another rating option may be performed by selecting a number of stars, as shown for criterion 412. This may be applicable for a criterion like “design” of a particular resource. Again, another criterion may have a UI representation in the form of a slider for a percentage value, such as criterion 414. If the user has selected a suitable rating by clicking with a pointing device on one of the UI representations 408, 410, 412 and 414, he may confirm this election by clicking on “OK.”

It may be noted that an administrator may have pre-assigned the various rating criteria and their graphical representations for the various resource types (not shown).

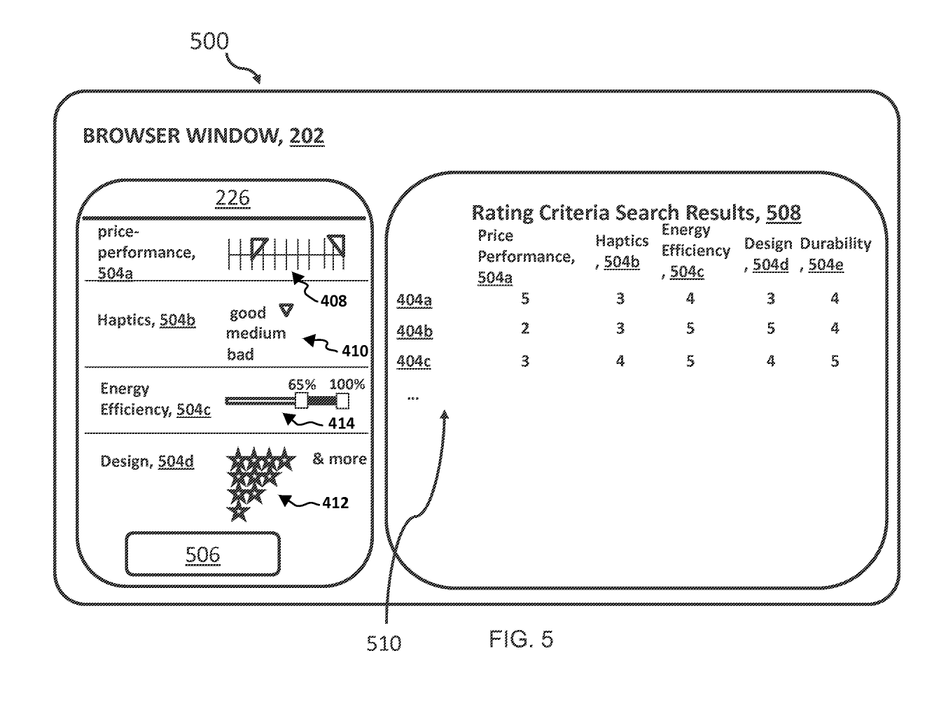

FIG. 5 shows an embodiment 500 of a selection result for resources 404a, 404b, and 404c. A user may have chosen rating values for a pre-selected resource (not shown in FIG. 5) via the rating criteria search widget 226 (FIG. 2). The rating criteria search widget 226 may be displayed in a browser window, such as browser window 202 to a user. The pre-defined resource-type-specific rating criteria 504a, 504b, 504c, and 504d are displayed in rating criteria search widget 226. Also shown are selected values or value ranges via UI representations 408, 410, 412, and 414 directly beside the resource-type-specific rating criteria. The user may start a selection process (see step 114, FIG. 1) by clicking on search button 506.

As a result, rating criteria search results 510 may be displayed in a separate portlet, such as search results portlet 508. Here various resources 404a, 404b, and 404b are listed along with their corresponding ratings for selected rating criteria 504a, 504b, 504c, 504d, and 504e.

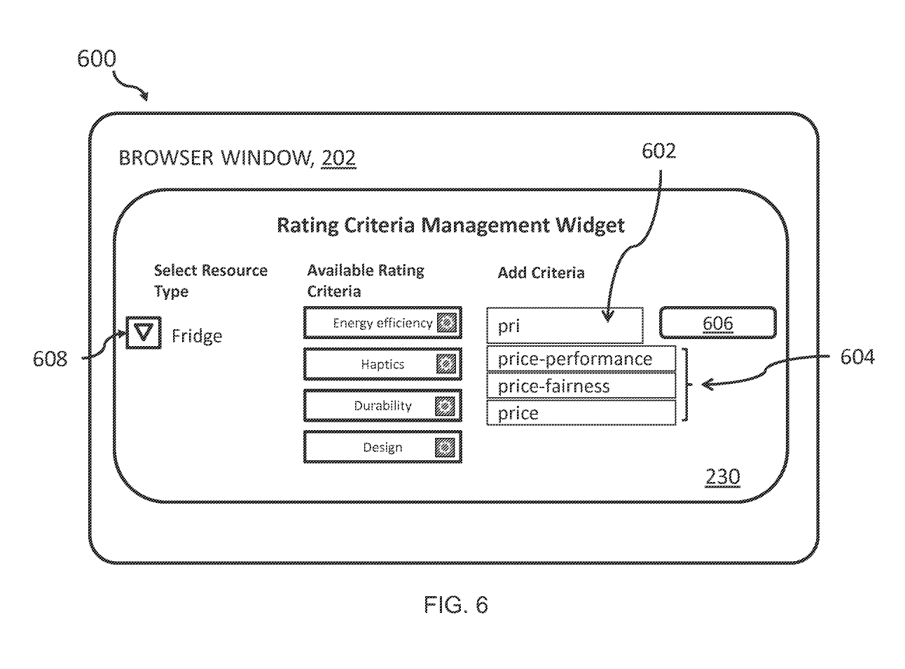

FIG. 6 shows an embodiment 600 of an input portlet, specifically, rating criteria management widget 230, for adding a user-specific criterion for a resource type. In this case, the selected resource type 608 may be a “fridge.” Available and shown rating criteria are “energy-efficiency,” “haptics,” “durability,” and “design.” In input window 602, a user may add an additional rating criterion. He may start typing an identifier for the rating criterion, as shown the user enters “pri.” In this example, one or more of pluggable suggestors 252 (FIG. 2), shown as “price-performance,” “price-fairness,” and “price,” are presented in list 604 as potential additional rating criteria in parallel to the typing action. By clicking on one of the suggested additional rating criterion with a pointing device, the user selects such an additional rating criterion. Alternatively, he may completely type an identifier for an additional rating criterion that may not appear in the list of suggestions 604. By clicking on an “add button” 606 when the field 602 is populated, the user adds an additional user-specific, or user-based, rating criterion. It may be assumed, as an example, that the user selects the additional rating criterion “price-fairness.”

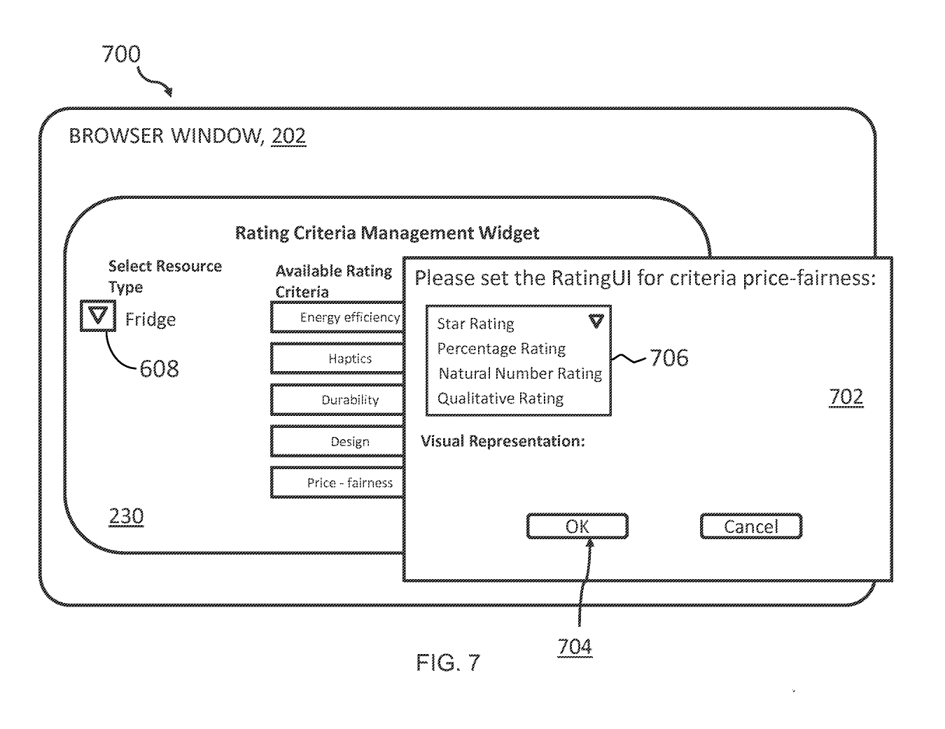

FIG. 7 shows an embodiment 700 of an assignment of a UI representation for a user-specific rating criterion “price-fairness” for resource type 608. For this purpose, rating UI sub-window 702 opens showing different pre-defined ratings representations 706 such as “star rating,” “percentage rating,” “natural number rating,” and “qualitative rating” as discussed in detail above. The user may choose one of the representations by clicking on the related button for the selected UI representation and confirm this step by clicking on a confirmation button 704. It may be assumed for this example that the user selects “percentage rating.”

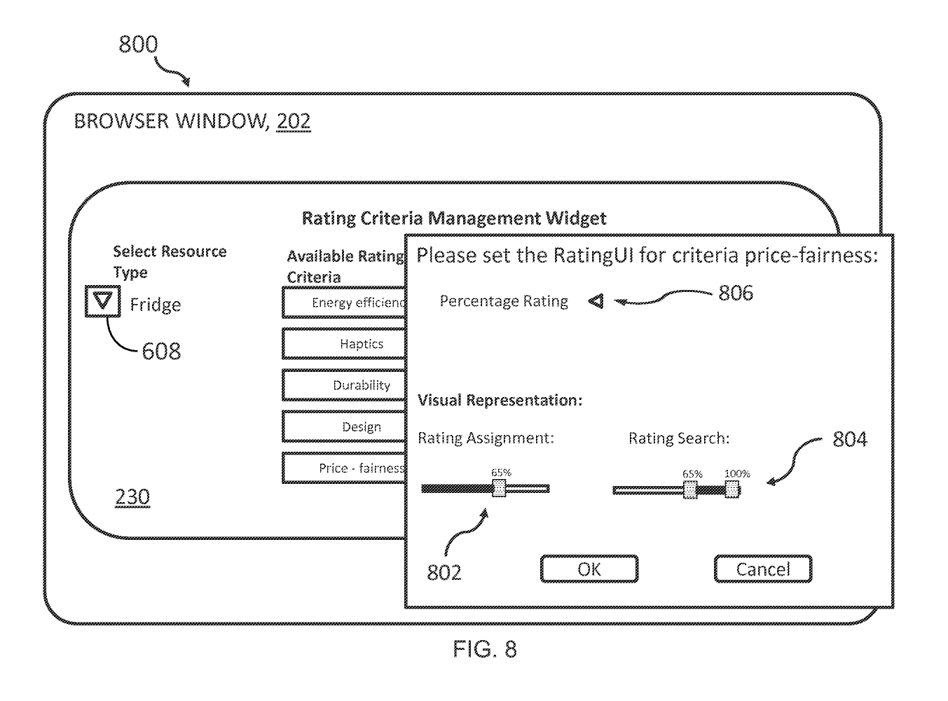

FIG. 8 shows another embodiment 800 of an assignment of a user interface representation for a user-specific criterion “percentage rating” 806 for a resource type 608. Here, a rating assignment 802 is assigned to the resource “fridge” 404, and/or a range setting 804 may be assigned as a condition for a selection process (see step 114, FIG. 1). For other rating criteria instead of the percentage rating 806, the dialogue widget may look a bit different. However, the general function may be the same: Assigning a visual representation to a rating criterion to select, assign and display an average rating value. If, for example, a user selects a start rating in the example used in the context of FIG. 7, the percentage rating 806 UI representations would be replaced by a corresponding star rating representation. A person skilled in the art will understand the differences in the various representations.

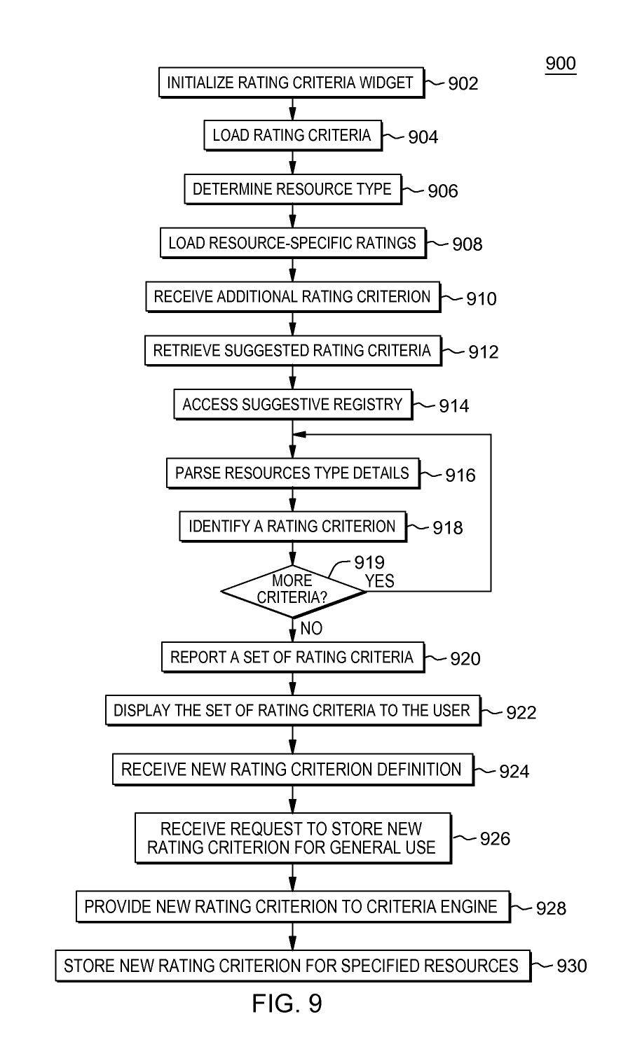

FIG. 9 shows flowchart 900 for registering a new rating criterion by either an administrator or a user. The user may here also be denoted as an administrator. Firstly 902, the user navigates to the rating criteria management widget 230 (FIG. 6). Then, 904 the rating criteria management widget 230 loads the available rating criteria from the resource type rating criteria engine 254 (FIG. 2). Next, the user selects, 906, a resource type 608 (FIG. 6) for which he wants to manage the rating criteria. In a next step, 908, the rating criteria management widget 230 loads the rating criteria already available for the selected resource type 608 from the resource type rating criteria engine 254. In a further step 910, the user intends to define an additional rating criterion for the resource type 608 at hand. Then 912, the rating criteria management widget 230 causes the rating criteria suggestion engine 242 (FIG. 2) to retrieve a set of suggested rating criteria.

As a next step 914, the rating criteria suggestion engine 242 accesses the rating criteria suggestive registry 250 (FIG. 2) and loads the pluggable suggestors 252 (FIG. 2), which may be provided out-of-the-box or added via a pluggable architecture. In step 916, the rating criteria suggestion engine 230 parses resource type details to the suggestor 252 to retrieve a suggested rating criterion. Next 918, at least one of the suggestors 252 analyzes the resource type details and returns a set of suggested rating criterion to the rating criteria suggestion engine 242. This process may be repeated several times by following the “Yes” branch of the decision step 919 when more criteria are required. Following the “No” branch, in a further step 920, the rating criteria suggestion engine 242 returns the set of suggested rating criteria back to the rating criteria management widget 230.

In a further step 922, the rating criteria management widget 230 represents the suggested rating criteria to the user for selection. The user accepts one of the suggested rating criteria or decides to define a new rating criterion, 924. The user may click “add”, 926, to persist the new rating criterion/criteria for the given resource type 608. The rating criteria management widget 230 then, 928, sends the new rating criteria definition to the resource type rating criteria engine 254. Finally 930, the resource type rating criteria engine 254 persists the new definition in the type criteria store 236.

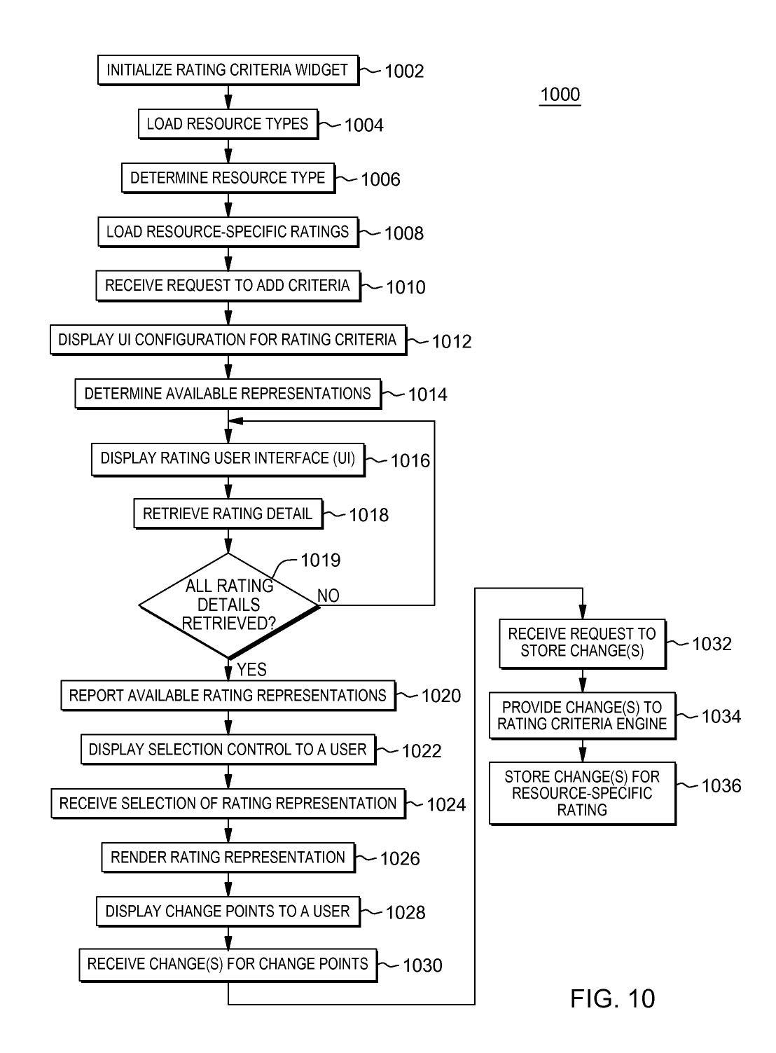

FIG. 10 shows a flowchart 1000 describing a configuration of a UI representation for a rating criterion. Firstly 1002, the administrator navigates to rating criteria management widget 230 (FIG. 6). It loads, 1004, the available resource types 608 (FIG. 6) from the resource type rating criteria engine 244 (FIG. 2). Next 1006, the administrator selects a resource type 608 for which he wants to manage the rating criteria. Then 1008, the rating criteria management widget 230 loads the rating criteria already available for the selected resource type 608 from the resource type rating criteria engine 244. In a next step 1010, the administrator clicks the control 606 (FIG. 6) to launch the rating criteria configuration widget 704 (FIG. 7) for a certain rating criteria, for example, price fairness. In a further step 1012, the rating criteria configuration widget displays the default UI configuration for the rating criteria at hand. In step 1014, the rating criteria configuration widget 230 accesses the rating UI artifact registry 258 (FIG. 3) to get all UI representations that are available (for example, list 706, FIG. 7). Then 1016, the rating UI artifact registry 258 loads plugged rating UI provider 260 (FIG. 3). Again next 1018, the rating UI artifact registry 258 retrieves rating UI details from the plugged rating UI provider 260. This may happen several times by following the “Yes” branch of the decision step 1019 when more rating details are to be retrieved.

Following the “No” branch, in a further step 1020, the rating UI artifact registry 258 returns the available rating UIs to the rating criteria configuration widget 260. Furthermore 1022, the rating criteria configuration widget 230 provides a selection control for the administrator to select the desired rating criterion UI. Additionally 1024, the administrator selects a rating criteria UI representation. In step 1026, the rating criteria configuration and management widget 230 renders the visual representation of the rating criterion UI for: 1) assigning a rating value, 2) searching for (range of) ratings, and 3) display an average value of ratings.

Then 1028, the rating criteria configuration widget 230 renders control to change points of variability (e.g., range of values, amount of stars) if available for the given rating UI. Now and optionally 1030, the administrator configures the points of variability of the rating UI. Next 1032, the administrator clicks “OK” to persist the UI configuration of the rating criterion. Additionally 1034, the rating criteria configuration widget 230 sends the new configuration to resource type rating criteria engine 254 which persists the information in the type criteria store 240.

In an optional dialogue, an administrator may consolidate rating criteria (no flowchart shown). Firstly, the administrator or user may navigate to the rating criteria management widget 230 (FIG. 6). It may load the available resource types 608 (FIG. 6) from the resource type rating criteria engine 254 (FIG. 2). The administrator or user selects a resource type 608 for which he wants to manage the rating criteria. The resource type 608 could also be preselected if the user enters this widget, e.g., from the rating widget 228 (FIG. 2) were the resource type 608 may already be set by the resource the user wants to rate. Then, the rating criteria management widget 230 loads the rating criteria already available for the selected resource type 608 from the resource type rating criteria engine 254.

The administrator or user detects that similar rating criteria may be present (for example, look or design) and wants to consolidate those. The user or administrator selects the rating criteria to be consolidated via drag-and-drop. He directs one rating criteria element (for example, look) onto another rating criteria element that is considered to be synonymous (for example, design).

The rating criteria management widget 230 presents a confirmation dialog to the user. Then the user may click on a confirmation button to persist his preference in the backend. The rating criteria management widget 230 sends the consolidated information to the rating criteria consolidation engine 246. The rating criteria consolidation engine 246 (FIG. 2) persists then the user's consolidation preference in a rating criteria consolidation store. Finally, the rating criteria management widget 213 (FIG. 2) displays the consolidated set of rating criteria for the given resource type 608.

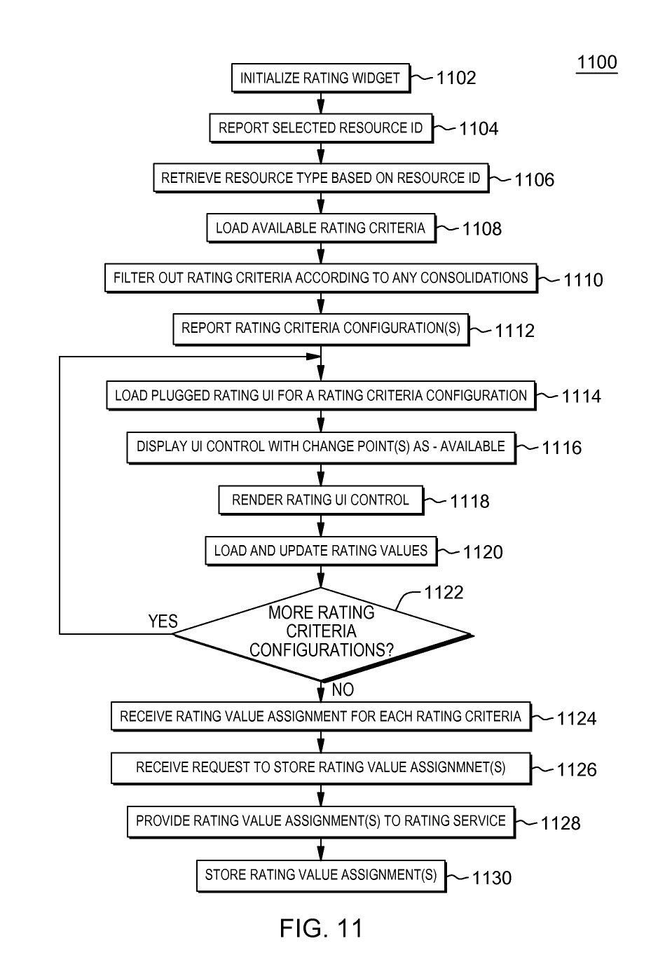

FIG. 11 shows a flowchart 1100 of creating rating values, in particular by a user. The different steps in the flowchart perform the following actions:
1102: The user navigates to any resource representation, such as 404a in FIG. 4, and clicks the control to launch the rating widget 406 (FIG. 4) (compare to rating widget 228, FIG. 2) for the resource in question.
1104: The rating widget 406 passes the ID of the selected resource to the resource type rating criteria engine 254 (FIG. 2) to load the criteria.
1106: The resource type rating criteria engine 254 queries the resource store 238 (FIG. 2) and retrieves the resource type 608 (FIG. 6) for the resource ID it received from the rating widget 406.
1108: The resource type rating criteria engine 254 accesses the type criteria store 240 (FIG. 2) and loads the rating criteria available for the given resource type 608.
1110: The resource type rating criteria engine 254 accesses the rating criteria consolidation engine 246 (FIG. 2) to filter out any rating criteria consolidations that have been performed by the user in the context of which the rating widget 406 is being loaded.
1112: The resource type rating criteria engine 254 passes the rating criteria configurations for the given resource type 608 back to the rating widget 406.
1114: The rating widget 406 accesses the rating UI artifact registry (see 258, FIG. 2) to load the plugged rating UI provider 260 based on the rating criteria configuration at hand.
1116: Optionally, the rating widget 406 prepares the rating UI control with the configured point of variability values (e.g., amount of stars).
1118: The rating widget 406 renders the rating UI control for the rating criterion at hand.
1120: The rating widget to 406 loads the rating value for the given resource ID for the rating criterion and adjusts the rendering of the rating UI controls accordingly.
1122: If there is another rating criteria configuration to process, then processing returns to step 1114 via the “Yes” branch. If not, then processing proceeds down the “No” branch to step 1124.
1124: The user specifies rating values for each rating criteria interacting with the configured rating UI.
1126: The user clicks “OK” to persist his rating value assignment for each rating criteria in the backend.
1128: The rating widget 406 sends the user's rating criteria values to the rating service 256 (see FIG. 2) for persistence.
1130: The rating service to 256 persists the user's rating value assignments in the resource rating store 234.

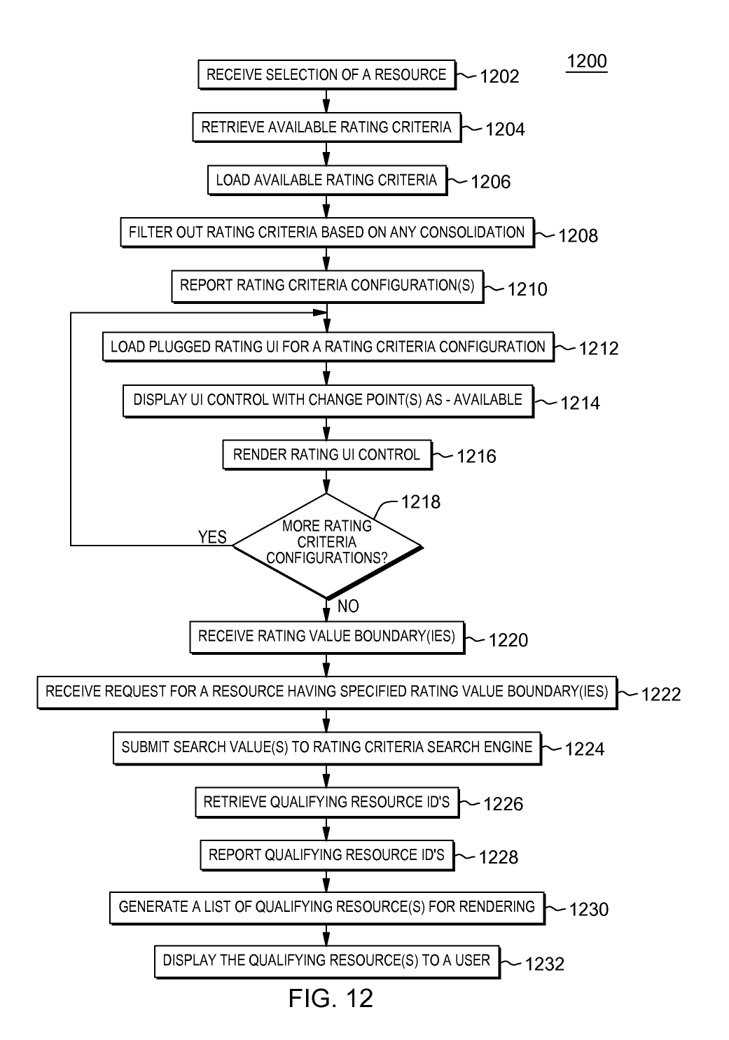

FIG. 12 shows a flowchart 1200 showing a flow of action for a search/selection based on rating criteria. This process may be performed by a user. The different steps in the flowchart 1200 perform the following actions:
1202: The user navigates to the rating criteria search widget 226 (FIG. 5), preselecting a resource type 608 (FIG. 6) he wants to search for.
1204: The rating criteria search widget 226 passes the selected resource type 608 to the resource type rating criteria engine 254 (FIG. 2) to retrieve the rating criteria available for the given resource type 608.
1206: The resource type rating criteria engine 254 accesses the type criteria store 240 (FIG. 2) and loads the rating criteria available for the given resource type 608.
1208: The resource type rating criteria engine 254 accesses the rating criteria consolidation engine 246 (FIG. 2) to filter out any rating criteria consolidations (See FIG. 6) that have been performed by the user in the context of which the rating criteria search widget 226 is being loaded.
1210: The resource type rating criteria engine 254 passes the rating criteria configurations for the given resource type 608 back to the rating criteria search widget 226.
1212: The resource type rating criteria engine 254 accesses the rating UI artifact registry 258 to load the plugged rating UI provider 260 based on the rating criteria configuration at hand.
1214: Optionally, the resource type rating criteria engine 254 prepares the rating search UI control with the configured point of variability values (e.g., amount of stars)
1216: The resource type rating criteria engine 254 renders the rating search UI control for the rating criteria at hand.
1218: If there is another rating criteria configuration to process, then processing returns to step 1112 via the “Yes” branch. If not, then processing proceeds down the “No” branch to step 1220.
1220: The user specifies rating criteria value boundaries for each rating criteria interacting with the configured rating search UI.
1222: User clicks “search” to trigger a search based on the specified rating criteria value boundaries in the backend.
1224: The resource type rating criteria engine 254 sends the user's rating criteria search values to the rating criteria search engine 254.
1226: The resource type rating criteria engine 254 queries the resource rating store 234 (FIG. 2) to retrieve the resources for which the values assigned to the specific rating criteria are within the bounds of the user-selected rating criteria value boundaries for all rating criteria.
1228: The resource type rating criteria engine 254 passes back the list of resources that match the aforementioned query.
1230: The rating criteria search engine 254 passes back the list of resources that match the aforementioned query.
1232: The rating criteria search widget 226 renders the resulting resources in the rating criteria search results section.

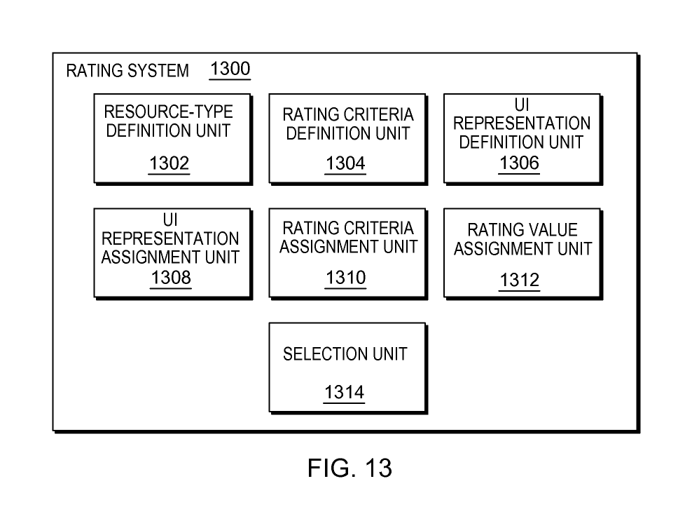

FIG. 13 shows a general block diagram of rating system 1300 for a multi-criteria rating of resources. The rating system may comprise a resource type definition unit 1302 adapted for a definition and storage of a resource type 608 (FIG. 6), a general rating criteria definition unit 1304 adapted for a definition and storage of general rating criteria and a user interface representation definition unit 1306 adapted for a definition and storage of user interface representations, such as 408, 410, 412, and 414 in FIG. 4. Furthermore, the rating system may comprise a user interface representation assignment unit 1308 adapted for an assignment of one representation out of the set of user interface representations for each of the general rating criteria, respectively.

Furthermore, the rating system may comprise a general rating criteria assignment unit 1310 adapted for an assignment of at least one out of the general rating criteria to the resource type 608, thereby generating resource-type-specific rating criteria out of the general rating criteria, a rating value assignment unit 1312 adapted for an assignment of a rating value to resource-type-specific rating criteria for the resource associated with the resource type 608 and a selection unit 1314 adapted for a selection of resources by a comparison of respective rating values of resources with the resource-type-specific rating criteria values.

Some helpful definitions follow:

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

The term “resource” may denote any subject that may have a rating from a plurality of users. A resource may, e.g., be a product, a service, an artist performance, a person or any other subject people may have an opinion about.

The term “resource type” may denote a category resources may be categorized into. Example of resource types may be microwave ovens, smart phones, TV sets, cars, holiday destinations, specific shops or any other type of product or service categories.

The term “general rating criterion” may denote a rating criterion that may not yet have been assigned to a resource type. General rating criteria may be defined independently of resource types and may be assigned individually to a specific resource type.

The term “user interface representations” may denote the kind of representation used for a specific rating. A user interface representation may comprise a certain number of stars, a number value, a percentage, a range of numbers or percentages, or any other suitable kind of graphical representation of a rating.

The term “resource-type-specific rating criterion” may denote a criterion that may have been assigned specifically to the resource type. Once a general rating criterion has been assigned to a specific resource type it becomes a resource-type-specific rating criterion.

The term “rating values” may denote any quantifiable measure that can be assigned to a resource-type-specific rating criterion. More specifically, rating values may be categorized in resource-type-specific rating criterion values.

The term “suggestor” may denote a function or a system suggesting to a user in a user interface a term to be used in an input field of the user interface. The user may or may not have started typing in a specific term. There may be different types of suggestors, like a type-ahead suggestor, a folksonomy suggestor or a suggestor performing a semantic text analysis of a resource type description to suggest a new specific resource-type-specific rating criterion.

The proposed computer-implemented method for a multi-criteria rating of resources and the related system may offer a couple of advantages and technical consequences:

A more detailed search and better targeted search possibilities are provided that may allow users to express preferences based on different resource criteria. This may lead to less network traffic and less resource utilization due to the fact alone that the probability for an additional search to return desired results is higher if compared with traditional techniques of ratings. Also the number of such tasks may be reduced which also may lead to a reduction in required processing power in backend systems. Furthermore, users may assign different weights to different criteria for an even more sophisticated and dedicated search for information about a resource type or resource respectively.

An additional set of criterion suggestors may help a user by offering additional rating capabilities/criteria, i.e., rating a given resource in an additional rating category. This in turn may lead to support the aforementioned aspects of being able to carry out more fine-grained searches which again in turn lead to reduced network traffic, reduced CPU consumption and reduced memory consumption.

It may also be highlighted that administrators and users are able to dynamically add new rating criteria. This may best be explained by an example: I a community member/admin/or a marketing function of an enterprise decides that a new rating criterion ‘cloud-readiness’ or ‘mobile support’ is required because new evolving techniques lead to new evolving assessment criteria then the proposed method and system allows to: dynamically add new criteria and have the criteria configured by, e.g., an administrator. After this is done, the added criterion will be visible right away to all users in other assignment widgets, other search controls, other resource details showing the rating values for each and every resource-type-specific rating criteria.

According to some embodiments of the present invention, a computer-implemented method for a multi-criteria rating of resources may be provided. The method may comprise defining and storing a resource type, defining and storing general rating criteria, defining and storing user interface representations and assigning one out of the user interface representations to each of the general rating criteria, respectively. The method may also comprise assigning at least one out of the general rating criteria to the resource type, thereby generating resource-type-specific rating criteria out of the general rating criteria, assigning rating values to resource-type-specific rating criteria for the resource associated with the resource type, and selecting resources by comparing respective rating values of resources with the resource-type-specific rating criteria values.

According to another embodiment of the present invention, a rating system for a multi-criteria rating of resources may be provided. The rating system may comprise a resource type definition unit adapted for a definition and storage of a resource type, a general rating criteria definition unit adapted for a definition and storage of general rating criteria, and a user interface representation definition unit adapted for a definition and storage of user interface representations. The rating system may also comprise a user interface representation assignment unit adapted for an assignment of one out of the user interface representations to each of the general rating criteria, respectively, a general rating criteria assignment unit adapted for an assignment of at least one out of the general rating criteria to the resource type, thereby generating resource-type-specific rating criteria out of the general rating criteria and a rating value assignment unit adapted for an assignment rating values to resource-type-specific rating criteria for the resource associated with the resource type.

Furthermore, the rating system may comprise a selection unit adapted for a selection of resources by a comparison of respective rating values of resources with the resource-type-specific rating criteria values.

Furthermore, embodiments may take the form of a related computer program product, accessible from a computer-usable or computer-readable medium providing program code for use, by or in connection with a computer or any instruction execution system. For the purpose of this description, a computer-usable or computer-readable medium may be any apparatus that may contain means for storing, communicating, propagating or transporting the program for use, by or in a connection with the instruction execution system, apparatus, or device.

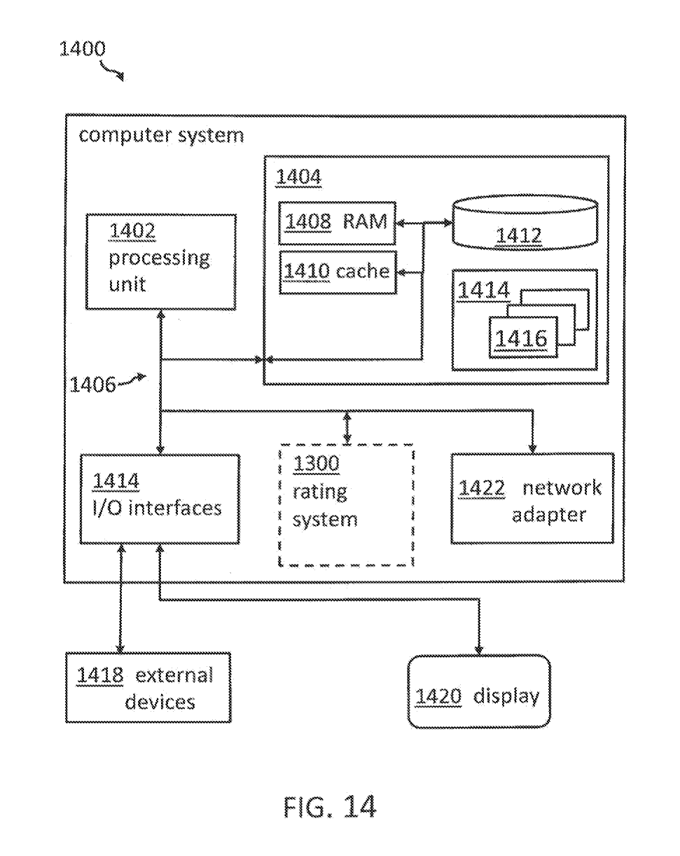

Some embodiments of the present invention may be implemented together with virtually any type of computer, regardless of the platform being suitable for storing and/or executing program code. For example, as shown in FIG. 14, a computing system 1400 is shown.

The computing system 1400 is only one example of a suitable computer system and is not intended to suggest any limitation as to the scope of use or functionality of some embodiments of the present invention described herein. Regardless, computer system 1400 is capable of being implemented and/or performing any of the functionality set forth hereinabove. In the computer system 1400, there are components, which are operational with numerous other general purpose or special purpose computing system environments or configurations. Examples of well-known computing systems, environments, and/or configurations that may be suitable for use with computer system/server 1400 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. Computer system/server 1400 may be described in the general context of computer system-executable instructions, such as program modules, being executed by a computer system 1400. Generally, program modules may include routines, programs, objects, components, logic, data structures, and so on that perform particular tasks or implement particular abstract data types. Computer system/server 1400 may be practiced in distributed cloud computing environments where tasks are performed by remote processing devices that are linked through a communications network. In a distributed cloud computing environment, program modules may be located in both local and remote computer system storage media including memory storage devices.

As shown in the figure, computer system/server 1400 is shown in the form of a general-purpose computing device. The components of computer system/server 1400 may include, but are not limited to, one or more processors or processing units 1402, a system memory 1404, and a bus 1406 that couples various system components including system memory 1404 to the processor 1402. Bus 1406 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus. \Computer system/server 1400 typically includes a variety of computer system readable media. Such media may be any available media that is accessible by computer system/server 1400, and it includes both, volatile and non-volatile media, removable and non-removable media.

The system memory 1404 may include computer system readable media in the form of volatile memory, such as random access memory (RAM) 1408 and/or cache memory 1410. Computer system/server 1400 may further include other removable/non-removable, volatile/non-volatile computer system storage media. By way of example only, storage system 1412 may be provided for reading from and writing to a non-removable, non-volatile magnetic media (not shown and typically called a ‘hard drive’). Although not shown, a magnetic disk drive for reading from and writing to a removable, non-volatile magnetic disk (e.g., a ‘floppy disk’), and an optical disk drive for reading from or writing to a removable, non-volatile optical disk such as a CD-ROM, DVD-ROM or other optical media may be provided. In such instances, each can be connected to bus 1406 by one or more data media interfaces. As will be further depicted and described below, memory 1404 may include at least one program product having a set (e.g., at least one) of program modules that are configured to carry out the functions of some embodiments of the present invention.

Program/utility 1414, having a set (at least one) of program modules 1416, may be stored in memory 1404 by way of example, and not limitation, as well as an operating system, one or more application programs, other program modules, and program data. Each of the operating system, one or more application programs, other program modules, and program data or some combination thereof, may include an implementation of a networking environment. Program modules 1416 generally carry out the functions and/or methodologies of some embodiments of the present invention as described herein.

The computer system/server 1400 may also communicate with one or more external devices 1418 such as a keyboard, a pointing device, a display 1420, etc.; one or more devices that enable a user to interact with computer system/server 1400; and/or any devices (e.g., network card, modem, etc.) that enable computer system/server 1400 to communicate with one or more other computing devices. Such communication can occur via Input/Output (I/O) interfaces 1414. Still yet, computer system/server 1400 may communicate with one or more networks such as a local area network (LAN), a general wide area network (WAN), and/or a public network (e.g., the Internet) via network adapter 1422. As depicted, network adapter 1422 may communicate with the other components of computer system/server 1400 via bus 1406. It should be understood that although not shown, other hardware and/or software components could be used in conjunction with computer system/server 1400. Examples, include, but are not limited to: microcode, device drivers, redundant processing units, external disk drive arrays, RAID systems, tape drives, and data archival storage systems, etc.

Additionally, the rating system 1300 for multi-criteria rating of resources may completely or in parts be attached to the bus system 1406.

The descriptions of the some embodiments of the present invention have been presented for purposes of illustration, but are not intended to be exhaustive or limited to the embodiments disclosed. Many modifications and variations will be apparent to those of ordinary skills in the art without departing from the scope and spirit of the described embodiments. The terminology used herein was chosen to best explain the principles of the embodiments, the practical application or technical improvement over technologies found in the marketplace, or to enable others of ordinary skills in the art to understand the embodiments disclosed herein.

The present invention may be embodied as a system, a method, and/or a computer program product. The computer program product may include a computer readable storage medium (or media) having computer readable program instructions thereon for causing a processor to carry out aspects of the present invention.

The medium may be an electronic, magnetic, optical, electromagnetic, infrared or a semi-conductor system for a propagation medium. Examples of a computer-readable medium may include a semi-conductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W), DVD and Blu-Ray-Disk.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to some embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and/or block diagrams in the Figures illustrate the architecture, functionality, and operation of possible implementations of systems, methods, and computer program products according to some embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to limit the present invention. As used herein, the singular forms “a”, “an” and “the” are intended to include the plural forms as well, unless the context clearly indicates otherwise. It will further be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or steps plus function elements in the claims below are intended to include any structure, material, or act for performing the function in combination with other claimed elements, as specifically claimed. The description of some embodiments of the present invention has been presented for purposes of illustration and description, but is not intended to be exhaustive or limited to the present invention in the form disclosed. Many modifications and variations will be apparent to those of ordinary skills in the art without departing from the scope and spirit of the present invention. The embodiments are chosen and described in order to best explain the principles of the present invention and the practical application, and to enable others of ordinary skills in the art to understand the present invention for various embodiments with various modifications, as are suited to the particular use contemplated.

1. A computer-implemented method for a multi-criteria rating of resources, the method comprising:
defining and storing a resource type;
defining and storing a set of pre-determined rating criteria;
defining and storing a set of user interface representations;
assigning a first user interface representation from the set of user interface representations to one or more of the pre-determined rating criteria from the set of pre-determined rating criteria;
assigning at least one pre-determined rating criterion of the set of pre-determined rating criteria to the resource type, thereby generating a resource-type-specific rating criterion;
assigning a rating value to the resource-type-specific rating criterion for a set of resources respectively, the set of resources designated as the resource type; and
selecting a resource by comparing the rating value respectively assigned to each resource of the set of resources.

2. The computer-implemented method according to claim 1, further comprising:
defining a respective weight for each of the resource-type-specific rating criterion.

3. The computer-implemented method according to claim 2, further comprising:
applying the respective weight to the rating value of each of resource-type-specific rating criterion.

4. The computer-implemented method according to claim 1, further comprising:
defining a user-based resource-type-specific rating criterion; and
assigning the user-based resource-type-specific rating criterion to the resource type.

5. The computer-implemented method according to claim 4, further comprising:
defining and storing a second user interface representation; and
assigning the second user interface representation to the user-based resource-type-specific rating criterion.

6. The computer-implemented method according to claim 5, further comprising:
preparing, by a suggestor, a list of potential user-based resource-type-specific rating criteria; and
selecting the user-based resource-type-specific rating criterion from the list of potential user-based resource-type-specific rating criteria.

7. The computer-implemented method according to claim 6, wherein the suggestor is one of a type-ahead suggestor, a folksonomy suggestor, and a suggestor performing semantic text analysis of a resource type description to suggest a potential user-based resource-type-specific rating criterion.

8. A computer system for a multi-criteria rating of resources, the computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to define and store a resource type;
second program instructions programmed to define and store a set of pre-determined rating criteria;
third program instructions programmed to define and store a set of user interface representations;
fourth program instructions programmed to assign a first user interface representation from the set of user interface representations to one or more of the pre-determined rating criteria from the set of pre-determined rating criteria;
fifth program instructions programmed to assign at least one pre-determined rating criterion of the set of pre-determined rating criteria to the resource type, thereby generating a resource-type-specific rating criterion;
sixth program instructions programmed to assign a rating value to the resource-type-specific rating criterion for a set of resources respectively, the set of resources designated as the resource type; and
seventh program instructions programmed to select a resource by comparing the rating value respectively assigned to each resource of the set of resources.

9. The rating system according to claim 8, further comprising:
eighth program instructions programmed to define a respective weight for each of the resource-type-specific rating criterion.

10. The rating system according to claim 9, further comprising:
ninth program instructions programmed to apply the respective weight to the rating value of each of resource-type-specific rating criterion.

11. The rating system according to claim 8, further comprising:
eighth program instructions programmed to define a user-based resource-type-specific rating criterion; and
ninth program instructions programmed to assign the user-based resource-type-specific rating criterion to the resource type.

12. The rating system according to claim 11, further comprising:
tenth program instructions programmed to define and store a second user interface representation; and
eleventh program instructions programmed to assign the second user interface representation to the user-based resource-type-specific rating criterion.

13. The ranking system according to claim 12, further comprising:
twelfth program instructions programmed to prepare, by a suggestor, a list of potential user-based resource-type-specific rating criteria; and
thirteenth program instructions programmed to select the user-based resource-type-specific rating criterion from the list of potential user-based resource-type-specific rating criteria.

14. The rating system according to claim 13, wherein the suggestor is one of a type-ahead suggestor, a folksonomy suggestor, and a suggestor performing semantic text analysis of a resource type description to suggest a potential user-based resource-type-specific rating criterion.

15. A computer program product for a multi-criteria rating of resources, the computer program product comprising a computer readable storage medium having stored thereon:
first program instructions programmed to define and store a resource type;
second program instructions programmed to define and store a set of pre-determined rating criteria;
third program instructions programmed to define and store a set of user interface representations;
fourth program instructions programmed to assign a first user interface representation from the set of user interface representations to one or more of the pre-determined rating criteria from the set of pre-determined rating criteria;
fifth program instructions programmed to assign at least one pre-determined rating criterion of the set of pre-determined rating criteria to the resource type, thereby generating a resource-type-specific rating criterion;
sixth program instructions programmed to assign a rating value to the resource-type-specific rating criterion for a set of resources respectively, the set of resources designated as the resource type; and
seventh program instructions programmed to select a resource by comparing the rating value respectively assigned to each resource of the set of resources.

16. The computer program product according to claim 15, further comprising:
eighth program instructions programmed to define a respective weight for each of the resource-type-specific rating criterion.

17. The computer program product according to claim 16, further comprising:
ninth program instructions programmed to apply the respective weight to the rating value of each of resource-type-specific rating criterion.

18. The computer program product according to claim 15, further comprising:
eighth program instructions programmed to define a user-based resource-type-specific rating criterion; and
ninth program instructions programmed to assign the user-based resource-type-specific rating criterion to the resource type.

19. The computer program product according to claim 18, further comprising:
tenth program instructions programmed to define and store a second user interface representation; and
eleventh program instructions programmed to assign the second user interface representation to the user-based resource-type-specific rating criterion.
